(19) United States
(12) Patent Application Publication
(10) Pub. No.: US 2022/0413419 A1
(43) Pub. Date: Dec. 29, 2022

(54) IMAGE FORMING APPARATUS

(71) Applicant: CANON KABUSHIKI KAISHA, Tokyo (JP)

(72) Inventor: Kenji Takagi, Kanagawa (JP)

(21) Appl. No.: 17/834,195

(22) Filed: Jun. 7, 2022

(30) Foreign Application Priority Data
Jun. 28, 2021 (JP) 2021-106559

(51) Int. Cl. G03G 15/20; G03G 15/00

(52) U.S. Cl. CPC G03G 15/2053; G03G 15/2064; G03G 15/2028; G03G 15/6582; G03G 15/6573; G03G 2215/00877

(57) ABSTRACT

An image forming apparatus includes an image forming portion, a fixing portion configured to heat and press the sheet conveyed from the image forming portion while nipping and conveying the sheet by a first nip portion to fix toner image to the sheet, a folding portion configured to fold the sheet, and a bonding portion configured to heat and press the sheet folded by the folding portion while nipping and conveying the sheet by a second nip portion to bond the sheet by powder adhesive. A peak value of pressure that the second rotary member pair applies to the sheet in the second nip portion is greater than a peak value of pressure that the first rotary member pair applies to the sheet in the first nip portion.

### BACKGROUND OF THE INVENTION

### Field of the Invention

The present invention relates to image forming apparatuses for forming images on sheets.

### Description of the Related Art

Heretofore, if there is a need to create a confidential document that requires sealing, such as a salary payment statement (also referred to as salary slip or payslip), a pre-printed sheet having an adhesive applied thereto in advance is prepared, and variable data is printed to each pre-printed sheet before the sheet is subjected to a sealing process performed as postprocessing. According to this method, creation of pre-printed sheets that requires application of adhesive takes up much time, and the application of the method to creating small quantities of printed products was inefficient.

Japanese Patent Application Laid-Open Publication No. 2006-171607 proposes an image forming apparatus that is designed to output a sealed document using normal paper by one apparatus through use of a powder adhesive, i.e., adhesive toner, in addition to toner for forming images, i.e., printing toner, via an electrophotographic process. According to this method, adhesive toner is applied to a sheet serving as a recording medium by being transferred via an electrophotographic process similar to toner for forming images. Thereafter, the sheet is folded with a surface on which the powder adhesive is formed placed on an inner side, and the folded sheet is heated and pressed, by which the sheet is bonded by the powder adhesive. Japanese Patent Application Laid-Open Publication No. 2008-170659 discloses a powder adhesive containing cyclic polyolefin resin and thermoplastic elastomer as the powder adhesive to be applied on a base sheet such as a pressure-bonded postcard, i.e., peel-and-reveal type postcard, via an electrophotographic method.

However, in a case where printing and bonding processes are performed by one image forming apparatus as according to the above-mentioned document, the following drawbacks may occur. In the bonding process, a surface on an outer side of the folded sheet comes into contact with a heating member such as a heating roller or a heating film and is heated thereby, and the heat is conducted through an internal layer under the surface of the sheet to heat the powder adhesive applied on the inner side of the folded sheet. In that state, the sheet is heated while being conveyed by a conveyance speed set in advance, such that if the temperature of the heating member is low, powder adhesive will not be sufficiently heated while the heating member is in contact with the sheet, and bonding failure may occur. Meanwhile, if the heating temperature during bonding is set excessively high, for example, printing toner fixed to the outer side surface of the sheet may be melted again and adhere to the heating member before being reattached to the sheet, by which a drawback such as image defects, so-called hot offset, may occur.

### SUMMARY OF THE INVENTION

The present invention provides an image forming apparatus that can achieve sufficient bonding strength without setting heating temperature during bonding excessively high.

According to one aspect of the invention, an image forming apparatus includes an image forming portion configured to form a toner image on a sheet using printing toner and to apply powder adhesive on the sheet, a fixing portion including a first rotary member pair that constitutes a first nip portion, the fixing portion being configured to heat and press the sheet conveyed from the image forming portion while nipping and conveying the sheet by the first nip portion to fix the toner image to the sheet, a folding portion configured to fold the sheet conveyed from the fixing portion such that a surface of the sheet on which the powder adhesive is applied is placed on an inner side of the sheet that is folded, and a bonding portion including a second rotary member pair that constitutes a second nip portion, the bonding portion being configured to heat and press the sheet folded by the folding portion while nipping and conveying the sheet by the second nip portion to bond the sheet by the powder adhesive, wherein a peak value of pressure that the second rotary member pair applies to the sheet in the second nip portion is greater than a peak value of pressure that the first rotary member pair applies to the sheet in the first nip portion.

Further features of the present invention will become apparent from the following description of exemplary embodiments with reference to the attached drawings.

### BRIEF DESCRIPTION OF THE DRAWINGS

FIG. 1 is a schematic drawing of an image forming apparatus according to an embodiment.

FIG. 2 is an explanatory view illustrating attachment of a postprocessing unit to an apparatus body of the image forming apparatus according to the embodiment.

FIG. 3 is a view illustrating a conveyance route of a sheet in the image forming apparatus according to the embodiment.

FIG. 4 is a view illustrating another conveyance route of a sheet in the image forming apparatus according to the embodiment.

FIGS. 5A to 5F are views illustrating a folding process according to the embodiment.

FIG. 6 is a perspective view illustrating an appearance of the image forming apparatus according to the embodiment.

FIGS. 7A and 7B are views illustrating examples of a product output from the image forming apparatus according to the embodiment.

FIG. 8 is a schematic drawing of a process cartridge according to the embodiment.

FIG. 9 is a schematic drawing of a first fixing unit according to the embodiment.

FIG. 10 is a schematic drawing of an inner side of the postprocessing unit according to the embodiment.

FIGS. 11A to 11C are graphs illustrating a pressure distribution at a fixing nip and a bonding nip.

FIG. 12 is a schematic diagram illustrating a setting condition for a bonding process.

FIG. 13A is a schematic diagram illustrating a state of contact between a fixing film and a sheet surface at the fixing nip.

FIG. 13B is a table showing parameters related to close contactness of FIG. 13A.

FIG. 13C is a schematic diagram illustrating a state of contact between sheets at the bonding nip.

FIG. 13D is a table showing parameters related to close contactness of FIG. 13C.

### DESCRIPTION OF THE EMBODIMENTS

An embodiment of the present disclosure will be described with reference to the drawings.

### Entire Configuration of Apparatus

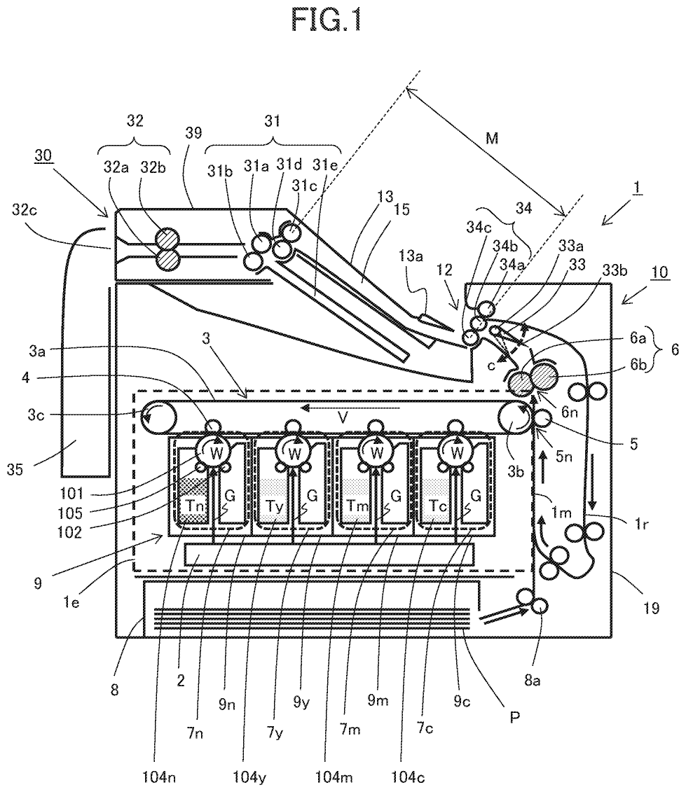

At first, the entire configuration of an image forming apparatus will be described with reference to FIGS. 1, 2 and 6. FIG. 1 is a schematic drawing illustrating a sectional configuration of an image forming apparatus 1 including a main body of the image forming apparatus according to the present embodiment, hereinafter referred to as an apparatus body 10, and a postprocessing unit 30 connected to the apparatus body 10. The image forming apparatus 1 is an electrophotographic image forming apparatus, i.e., an electrophotographic system, composed of the apparatus body 10 having a printing function adopting an electrophotographic system and the postprocessing unit 30 serving as a sheet processing apparatus.

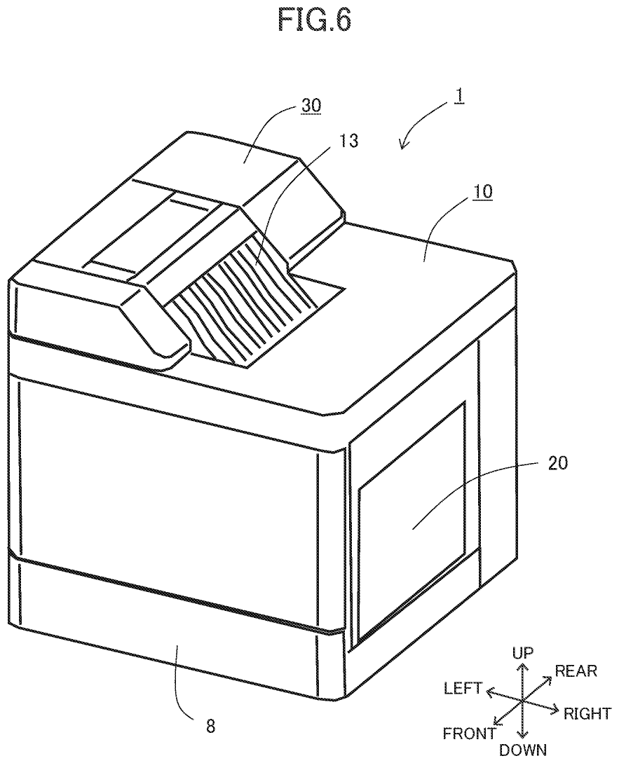

FIG. 6 is a perspective view illustrating an outer appearance of the image forming apparatus 1. The postprocessing unit 30 is attached to an upper portion of the apparatus body 10. The image forming apparatus 1 includes a sheet cassette 8 arranged at a lower portion, a tray 20 arranged on a right side of the apparatus that can be opened and closed, and a first sheet discharge tray 13 arranged at an upper side of the apparatus.

At first, an internal configuration of the apparatus body 10 will be described. As illustrated in FIG. 1, the apparatus body 10 includes the sheet cassette 8 serving as a sheet storage portion that stores sheets P serving as a recording medium, an image forming unit 1e serving as an image forming portion, a fixing unit 6 serving as a fixing portion, and a casing 19 housing these components. The apparatus body 10 has a printing function of forming a toner image by the image forming unit 1e on the sheet P being fed from the sheet cassette 8 and creating a printed product subjected to a fixing process by the fixing unit 6. Paper can be used, for example, as the sheet P serving as the recording medium.

The sheet cassette 8 is inserted in a drawable manner to the casing 19 at a lower part of the apparatus body 10, and stores multiple sheets P. The sheets P stored in the sheet cassette 8 are fed from the sheet cassette 8 by a feeding member such as a feed roller, and one of the sheets P is separated from other sheets by a separation roller pair and conveyed by a conveyance roller 8a. It is also possible to feed sheets one at a time that are set on a tray 20 arranged in an opened state (FIG. 6).

The image forming unit 1e is a tandem-type electrophotographic unit including four process cartridges 7n, 7y, 7m, and 7c, a scanner unit 2, and a transfer unit 3. A process cartridge is a unit that includes a plurality of components used to carrying out an image forming process, which can be replaced integrally. A cartridge supporting portion 9 that is supported on the casing 19 is provided in the apparatus body 10, and the respective process cartridges 7n, 7y, 7m, and 7c are detachably attached to attachment portions 9n, 9y, 9m, and 9c provided on the cartridge supporting portion 9. The cartridge supporting portion 9 may also be a tray member that can be drawn out of the casing 19.

The process cartridges 7n, 7y, 7m, and 7c adopt substantially the same configuration, except for the different types of powder material stored in the four powder storage portions 104n, 104y, 104m, and 104c. That is, each of the process cartridges 7n, 7y, 7m, and 7c includes a photosensitive drum 101 serving as an image bearing member, a charge roller 102 serving as a charger, one of powder storage portions 104n, 104y, 104m, and 104c storing powder material, and a developing roller 105 that develops image using the powder material.

Among the four powder storage portions, three powder storage portions 104y, 104m, and 104c arranged on the right side in the drawing store printing toner Ty, Tm, and Tc of yellow, magenta, and cyan as toner, i.e., first powder material or powder developer, for forming a visible image on the sheet P. Meanwhile, the powder storage portion 104n on the leftmost side in the drawing stores the powder adhesive Tn which is toner, i.e., second powder material, for performing a bonding process after printing. The powder storage portions 104y, 104m, and 104c are each an example of a first storage portion storing printing toner, and the powder storage portion 104n is an example of a second storage portion storing powder adhesive. Further, the process cartridges 7y, 7m, and 7c are each an example of a first process unit for forming a toner image using printing toner, and a process cartridge 7n is an example of a second process unit for forming an image of powder adhesive according to a predetermined application pattern.

According to the present embodiment, in order to print a black image such as a text image, process black in which color toners of yellow (Ty), magenta (Tm), and cyan (Tc) are superposed to create black is used. However, it is possible to add a fifth process cartridge containing black printing toner to the image forming unit 1e and so that a black image can be formed using black printing toner. The types and number of printing toner can be varied according to the purpose of use of the image forming apparatus 1.

The scanner unit 2 is arranged below the process cartridges 7n, 7y, 7m, and 7c and above the sheet cassette 8. The scanner unit 2 is an exposure unit of the present embodiment that emits laser light G to the photosensitive drum 101 of each of the process cartridges 7n, 7y, 7m, and 7c to form an electrostatic latent image.

The transfer unit 3 is equipped with a transfer belt 3a that serves as an intermediate transfer body, i.e., secondary image bearing member. The transfer belt 3a is a belt member wound around a secondary transfer inner roller 3b and a tension roller 3c, and an outer peripheral surface of the transfer belt 3a opposes the photosensitive drums 101 of the respective process cartridges 7n, 7y, 7m, and 7c. Primary transfer rollers 4 are arranged at positions corresponding to respective photosensitive drums 101 on the inner circumferential side of the transfer belt 3a. Further, a secondary transfer roller 5 serving as a transfer member is arranged at a position opposing the secondary transfer inner roller 3b. A transfer nip 5N formed between the secondary transfer roller 5 and the transfer belt 3a is a transfer portion, i.e., secondary transfer portion, where the toner image is transferred from the transfer belt 3a to the sheet P.

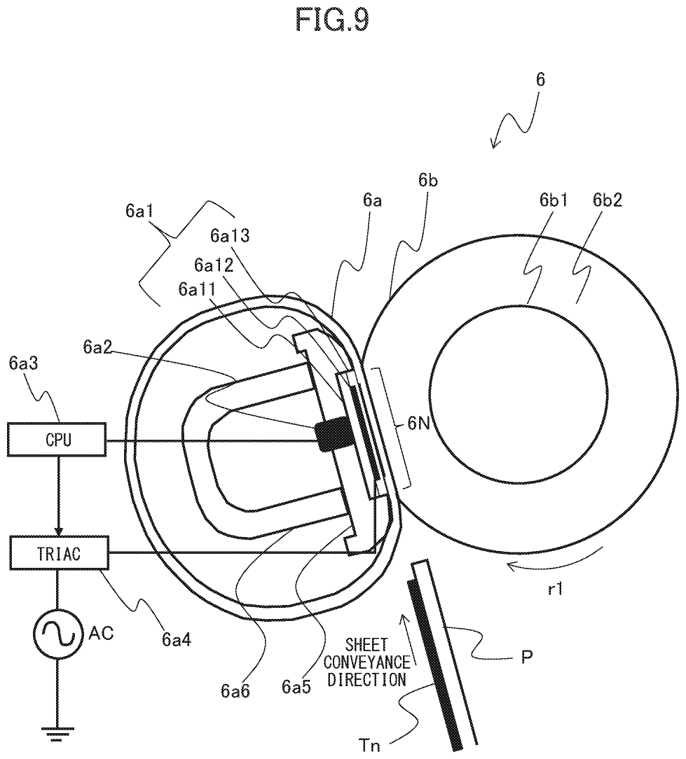

The fixing unit 6 is arranged above the secondary transfer roller 5. FIG. 9 is a detailed view of the fixing unit 6. The fixing unit 6 includes a tubular fixing film, i.e., endless belt, 6a, a heater 6a1 that contacts an inner surface of the fixing film 6a, and a pressure roller 6b that forms a fixing nip 6N with the heater 6a1 via the fixing film 6a. The fixing film 6a is a heating member, i.e., first heating member, according to the present embodiment, and the heater 6a1 is a first heating mechanism according to the present embodiment. The fixing film 6a and the pressure roller 6b function as a rotary member pair, i.e., first rotary member pair, that nips the sheet P by the fixing nip 6N serving as a first nip portion and rotates to convey the sheet P.

The fixing film 6a is a film member having heat resistance and flexibility. The fixing film 6a can have a base layer with a thickness of 60 μm formed of polyimide, an elastic layer having a thickness of 0.3 mm formed of silicone rubber formed thereon, and a release layer having a thickness of 20 μm formed of fluororesin such as perfluoroalkoxy alkanes (PFA) formed thereon. A surface roughness, i.e., arithmetic mean roughness Ra value, of a surface of the fixing film is set to 0.4 μm or less to realize sufficient smoothness. The surface roughness, i.e., Ra value, mentioned here is a value measured using a surface roughness measuring instrument SE-3400 (product of Kosaka Laboratory Ltd.). A cutoff wavelength is set to 0.80 mm or higher. An inner diameter of the fixing film 6a is 24 mm, and a width of the fixing film 6a in a longitudinal direction of the fixing nip 6N is 240 mm. A surface layer of the fixing film 6a is the surface that comes into contact with toner having been melted or softened by heat, and the toner surface after completing the fixing process is smoothed along the surface shape of the fixing film 6a, as described below. The longitudinal direction of the fixing nip 6N is a direction orthogonal to a sheet conveyance direction at the fixing nip 6N, and the direction is approximately parallel with a rotational axis direction of the pressure roller 6b and a main scanning direction during image forming.

The pressure roller 6b includes a core metal 6b1, an elastic layer 6b2 formed on an outer periphery of the core metal 6b1, and a release layer formed on the outermost surface. The core metal 6b1 is formed of iron, for example. The elastic layer 6b2 is a layer formed of soft silicone rubber having a thickness of 4.0 mm, for example. The release layer is formed of fluororesin, such as PFA or polytetrafluoroethylene (PTFE). Hardness of the silicone rubber used for the pressure roller 6b is approximately 20° by Asker C durometer (product of Kobunshi Keiki Co., Ltd.). The pressure roller 6b has a shaft portion arranged at an end portion in the axial direction of the core metal 6b1 formed of iron connected to a driving gear not shown, and it is driven to rotate by receiving power from a motor installed in the apparatus body 10 via the driving gear. A length of the outer peripheral surface of the pressure roller 6b in a longitudinal direction, that is, axial direction of the pressure roller 6b, of the fixing nip 6N, in other words, the length of the area in which the elastic layer 6b2 and the release layer are formed, is 230 mm, and a diameter of the outer peripheral surface of the pressure roller 6b is 25 mm.

The heater 6a1 serving as a heating mechanism, i.e., first heating mechanism, includes a base plate 6a11 having a thin plate shape, and a heating resistor 6a12 and an insulation protecting layer 6a13 formed on the base plate 6a11. A thin plate having a thickness of 0.7 mm mainly composed of ceramic material such as alumina can be used as the base plate 6a11. The heating resistor 6a12 is formed of a material that generates heat when electric current passes therethrough, such as Ag/Pd (silver-palladium). The insulation protecting layer 6a13 is formed of a material having insulation property, which according to the present embodiment is glass. A width of the heater 6a1 in the sheet conveyance direction is 8.7 mm, and a width of the heater 6a1 in a longitudinal direction of the fixing nip 6N is 240 mm.

A temperature detecting element 6a2 such as a thermistor is in contact with the base plate 6a11 and is electrically connected with a CPU 6a3 serving as a control unit installed in the image forming apparatus 1. The heater 6a1 is heated by supplying electric current to the heating resistor 6a12. The heat is detected by the temperature detecting element 6a2, and the CPU 6a3 controls power supply to the heating resistor 6a12 via a triac 6a4. For example, control is performed to increase the electric energy supplied to the heating resistor 6a12 to raise the temperature of the heater 6a1 if a detected temperature of the temperature detecting element 6a2 is lower than a set temperature set in advance and to reduce the electric energy to lower the temperature if it is higher than the set temperature. Thereby, the heater 6a1 is maintained to approximately a constant temperature. According to the present embodiment, the CPU 6a3 controls power supply to the heater 6a1 such that a surface temperature of the fixing film 6a is 175° C., which is a target temperature.

The heater 6a1 is held by a holding member 6a5 made of heat-resistant resin such as liquid crystal polymer (LCP). The holding member 6a5 also has a guiding function to guide the rotation of the fixing film 6a. The holding member 6a5 receives force applied in a direction toward approaching the pressure roller 6b from a spring not shown attached to a stay 6a6 made of metal. The pressure roller 6b is in pressure contact with the fixing film 6a toward the direction of the heater 6a1 with a total pressure of 25 kgf by a pressurizing mechanism such as a spring member not shown. Thereby, the fixing nip 6N is formed between the pressure roller 6b and a nip forming unit composed of the heater 6a1 and the holding member 6a5. Widths of the fixing nip 6N in the longitudinal direction and in the sheet conveyance direction are vertical and horizontal lengths of an approximately rectangular range in which the heater 6a1 and the pressure roller 6b are in pressure contact with each other interposing the fixing film 6a. According to the configuration example described above, the width of the fixing nip 6N in the longitudinal direction is 230 mm, which corresponds to the length of the pressure roller 6b. The width of the fixing nip 6N in the sheet conveyance direction can be measured by a measurement method using a pressure sensor sheet described below.

The pressure roller 6b receives power from a motor not shown to rotate in the direction of arrow r1 in FIG. 9, and the fixing film 6a is rotated by following the rotation of the pressure roller 6b by frictional force received from the pressure roller 6b. The sheet P bearing an unfixed toner image is conveyed together with the fixing film 6a through the fixing nip 6N in the sheet conveyance direction while having a surface, i.e., image surface, of the sheet P bearing the toner image and the powder adhesive Tn in close contact with an outer surface of the fixing film 6a at the fixing nip 6N. Since a thermal capacity of the fixing film 6a and the heater 6a1 is especially small and the holding member 6a5 is formed of a material having high heat insulating property, the surface of the fixing film 6a can be raised to a high temperature speedily and with a small heat supply according to the characteristic configuration of the present embodiment.

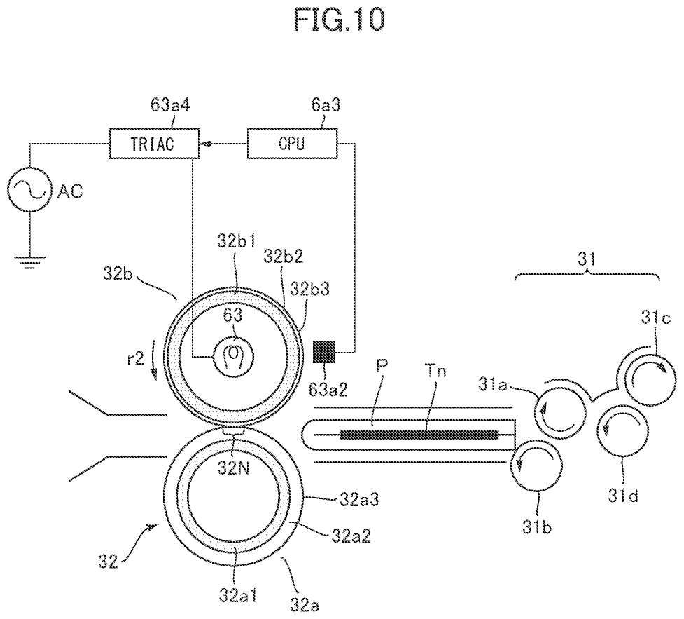

The nip forming unit can adopt a configuration not only in which the heater 6a1 is in direct contact with the inner side of the fixing film 6a but also in which the heater 6a1 is in contact with the fixing film 6a via a sheet material or a plate material having a high thermal conductivity such as iron alloy or aluminum. Further, a fixing unit equipped with a roller pair and a halogen heater, such as a bonding unit 32 (FIG. 10) described below, can be used as the fixing unit 6.

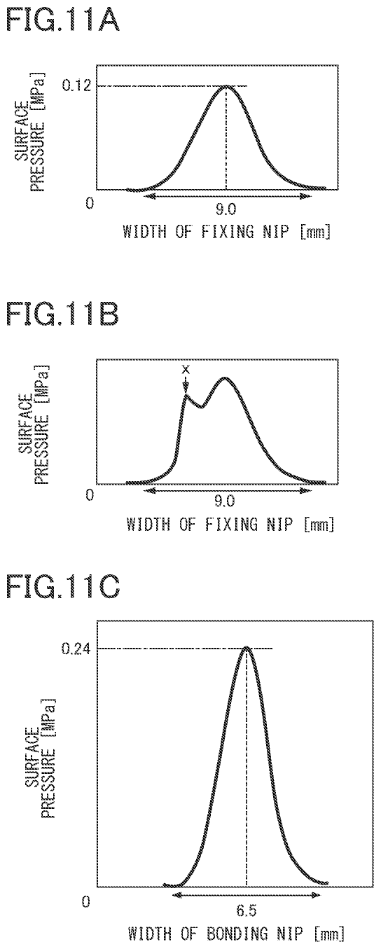

FIG. 11A illustrates a pressure distribution at the fixing nip 6N in the sheet conveyance direction. The pressure at the fixing nip 6N refers to a force applied per unit area to a surface of the sheet P, i.e., surface pressure, by being nipped between the fixing film 6a and the pressure roller 6b at the fixing nip 6N. In the drawing, the pressure distribution measured at a center portion of the fixing nip 6N in the longitudinal direction of the fixing nip 6N is illustrated. The measurement of pressure is performed using a roller pressure distribution measurement system (PINCH), which is a product of Nitta Corporation, and measurement is performed by nipping a pressure sensor sheet having piezoelectric elements not shown by the fixing nip 6N. Resolution of the pressure sensor sheet is 0.5 mm in the sheet conveyance direction. Measurement result of the pressure distribution illustrated in FIG. 11A is a mean value of the results obtained by repeatedly performing measurements using the pressure sensor sheet for five times.

As illustrated in FIG. 11A, a length of the fixing nip 6N in the sheet conveyance direction, i.e., pressurizing width or nip width, was 9.0 mm, and a peak value, i.e., maximum value, of pressure within the fixing nip 6N was approximately 0.12 MPa. In order to derive the peak value of pressure within the fixing nip 6N, the resolution is preferably 10% or less of the pressurizing width of the fixing nip 6N in the sheet conveyance direction. As illustrated in FIG. 11B, electronic noise (x) may be superposed on the measurement result of one pressure distribution. Therefore the effect of electronic noise is preferably reduced by acquiring a mean value of multiple measurement results. Further according to the present embodiment, the pressure distribution in the sheet conveyance direction is approximately uniform throughout the whole area of the fixing nip 6N in the longitudinal direction including both end portions and the center portion of the fixing nip 6N.

A sheet discharge port 12, i.e., first sheet discharge port, serving as an opening portion for discharging the sheet P from the apparatus body 10 is formed on the casing 19, and a sheet discharge unit 34 is arranged on the sheet discharge port 12. The sheet discharge unit 34 serving as a sheet discharge portion according to the present embodiment adopts a so-called triple roller configuration composed of a first sheet discharge roller 34a, an intermediate roller 34b, and a second sheet discharge roller 34c. Further, a switching guide 33 which is a flap-shaped guide that switches the conveyance route of the sheet P is provided between the fixing unit 6 and the sheet discharge unit 34. The switching guide 33 is pivotable around a shaft portion 33a such that a tip 33b of the switching guide 33 moves back and forth in a direction of arrow c in the drawing.

The apparatus body 10 is equipped with a mechanism for performing duplex printing. A motor not shown is connected to the sheet discharge unit 34 for rotating the intermediate roller 34b in both a normal direction and a reverse direction. A duplex conveyance path 1r that serves as a conveyance path connected in a loop to a main conveyance path 1m is provided. The sheet P having an image formed on a first side while passing through the main conveyance path 1m is nipped and conveyed by the first sheet discharge roller 34a and the intermediate roller 34b via the switching guide 33 pivoted in a clockwise direction, the position of which is shown by a dashed line. After a trailing edge of the sheet P in a feed direction passes through the switching guide 33, the switching guide 33 pivots in a counterclockwise direction, the position of which is shown by a solid line, and the rotation of the intermediate roller 34b is reversed, by which the sheet P is conveyed in a reverse manner to the duplex conveyance path 1r. While the sheet P having the front and back sides reversed passes through the main conveyance path 1m again, an image is formed on a second side of the sheet P. The sheet P after being subjected to duplex printing is guided by the switching guide 33 pivoted in the counterclockwise direction, the position of which is shown by the solid line, and the sheet P is nipped and conveyed by the intermediate roller 34b and the second sheet discharge roller 34c to be discharged from the apparatus body 10.

The conveyance route that passes the conveyance roller 8a, the transfer nip 5N, and the fixing nip 6N in the apparatus body 10 constitutes the main conveyance path 1m through which image is formed on the sheet P. The main conveyance path 1m extends from a position lower than to a position upper than the image forming unit 1e through one side in a horizontal direction when viewed in a main scanning direction for forming an image, that is, a width direction of the sheet perpendicular to a conveyance direction of the sheet conveyed in the main conveyance path 1m. In other words, the apparatus body 10 according to the present embodiment is a so-called perpendicular conveyance-type, also referred to as vertical path-type, printer in which the main conveyance path 1m extends in an approximately vertical direction. When viewed in the vertical direction, a first sheet discharge tray 13, an intermediate path 15, and the sheet cassette 8 are mutually overlapped. Therefore, the direction of movement of the sheet with respect to the horizontal direction when the sheet discharge unit 34 discharges the sheet P is opposite to the direction of movement of the sheet with respect to the horizontal direction when the sheet P is fed from the sheet cassette 8.

In the viewpoint of FIG. 1, that is, when viewed in the main scanning direction for forming an image, an occupation range in the horizontal direction of the main body portion excluding a second sheet discharge tray 35 of the postprocessing unit 30 preferably falls within an occupation range of the apparatus body 10. By designing the postprocessing unit 30 to fit in the space above the apparatus body 10, the image forming apparatus 1 having a printing-and-bonding function can be installed in an installation space of approximately a same size as a normal vertical path-type printer.

### Postprocessing Unit

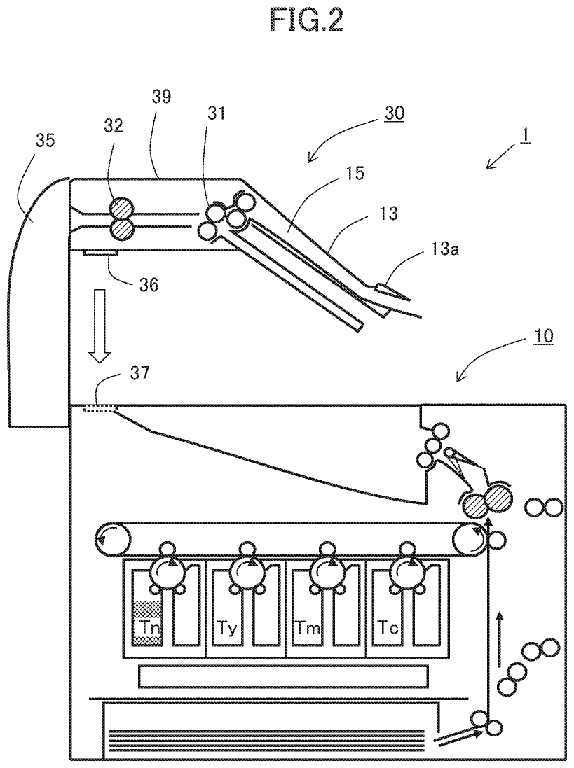

As illustrated in FIG. 2, the postprocessing unit 30 is attached to the upper portion of the apparatus body 10. The postprocessing unit 30 is a postprocessing unit in which a folding unit 31 serving as a folding portion and a bonding unit 32 serving as a bonding portion are housed integrally in a casing, i.e., second casing, 39.

The bonding unit 32 includes, as illustrated in FIG. 10, a heating roller 32b having a hollow shape serving as a heating member, i.e., second heating member, and a pressure roller 32a serving as a pressure member being in pressure contact with the heating roller 32b. The bonding unit 32 includes a halogen heater 63 serving as a heating mechanism, i.e., second heating mechanism, that is arranged on the inner side of the heating roller 32b. The heating roller 32b and the pressure roller 32a function as a second rotary member pair that rotates to nip and convey the sheet P by a bonding nip 32N serving as a second nip portion. The bonding unit 32 heats and presses the sheet P conveyed in a folded state from the folding unit 31 by nipping and conveying the sheet P by the bonding nip 32N, i.e., second fixing nip, which is the nip portion between the heating roller 32b and the pressure roller 32a. Thereby, the bonding unit 32 softens the powder adhesive Tn applied to an inner side surface of the sheet P in the folded state, to bond the sheet P.

The heating roller 32b includes a core metal 32b1, an elastic layer 32b2 formed on an outer peripheral side of the core metal 32b1, and a release layer 32b3 disposed on an outermost surface. The core metal 32b1 is formed of iron, for example. The elastic layer 32b2 is a layer having a thickness of 0.3 mm formed of hard silicon rubber, for example. The release layer 32b3 is formed of fluororesin, such as PFA. A diameter of the heating roller 32b is set to 50 mm. Further, the heating roller 32b rotates in an arrow r2 direction by having power transmitted from a motor not shown disposed in the postprocessing unit 30. The pressure roller 32a rotates following the rotation of the heating roller 32b by frictional force received from the rotating heating roller 32b.

The pressure roller 32a includes a core metal 32a1, an elastic layer 32a2 formed on an outer peripheral side of the core metal 32a1, and a release layer 32a3 arranged on the outermost surface. The core metal 32a1 is made of iron, for example. The elastic layer 32a2 is a layer having a thickness of 4.5 mm made of silicone rubber having a Shore A hardness of 20°, for example. The release layer 32a3 is a 50 μm layer made of fluororesin, for example. A diameter of the pressure roller 32a is set to 40 mm. The pressure roller 32a is in pressure contact with the heating roller 32b with a total pressure of 45 kgf by having a bearing member supporting the core metal 32a1 urged by a pressurizing mechanism such as a spring member not shown. Thereby, the bonding nip 32N is formed between the heating roller 32b and the pressure roller 32a. Widths of the bonding nip 32N in the longitudinal direction and in the sheet conveyance direction are vertical and horizontal lengths of an approximately rectangular range in which the heating roller 32b and the pressure roller 32a are in pressure contact with each other. According to the configuration example described above, the width of the bonding nip 32N in the longitudinal direction is 230 mm, which is approximately the same as the fixing nip 6N. The width of the bonding nip 32N in the sheet conveyance direction can be measured by a measurement method using a pressure sensor sheet described below.

The surface temperature of the heating roller 32b is detected by a non-contact-type temperature detecting element 63a2 that is arranged in a manner opposed to the outer peripheral surface of the heating roller 32b. The temperature detecting element 63a2 is electrically connected to the CPU 6a3 of the image forming apparatus 1. The CPU 6a3 controls the power supply to the halogen heater 63 by controlling a triac 63a4 disposed on a power supply path from an alternating current power supply AC to the halogen heater 63 based on a detection signal of the temperature detecting element 63a2. According to the present embodiment, the CPU 6a3 controls power supply to the halogen heater 63 such that a surface temperature of the heating roller 32b is 160° C., which is the target temperature.

It is also possible to adopt a configuration in which a heater such as a ceramic heater is arranged on an inner side of a tubular film, such as the fixing unit 6 (FIG. 9) described above, as the bonding unit 32, and to heat the sheet P by the film being heated by thermal conduction, i.e., non-radiation heat, from the heater. Further, whether to adopt a film or a thermal roller system in the fixing unit 6 and the bonding unit 32 serving as image heating units can be determined arbitrarily based on total consideration of the characteristics of the systems including a quick-start property, a thermal capacity, i.e., stability of heating temperature, and energy saving property.

FIG. 11C illustrates a pressure distribution of the bonding nip 32N in the sheet conveyance direction measured using the above-mentioned roller pressure distribution measurement system (PINCH). The pressure at the bonding nip 32N refers to a force applied per unit area to a surface of the sheet P, i.e., surface pressure, by being nipped between the heating roller 32b and the pressure roller 32a at the bonding nip 32N. In the drawing, the pressure distribution measured at a center portion of the bonding nip 32N in the longitudinal direction of the bonding nip 32N is illustrated. The details of the measurement method of pressure are the same as those of the fixing nip 6N.

As illustrated in FIG. 11C, according to the configuration example of the present embodiment, a length of the bonding nip 32N in the sheet conveyance direction, i.e., pressurizing width or nip width, was 6.5 mm, and a peak value, i.e., maximum value, of pressure within the bonding nip 32N was approximately 0.24 MPa. The nip width of the bonding nip 32N is shorter than the nip width of the fixing nip 6N. In this case, even if the peak value of nip pressure at the bonding nip 32N is set greater than the peak value of the nip pressure at the fixing nip 6N, a ratio of the total pressure of the bonding nip 32N to the total pressure of the fixing nip 6N will not be as great as the ratio of the peak values. Further according to the present embodiment, the pressure distribution in the sheet conveyance direction is approximately uniform throughout the whole area of the bonding nip 32N in the longitudinal direction including both end portions and the center portion of the bonding nip 32N.

Further, the postprocessing unit 30 includes the first sheet discharge tray 13 for rotatably supporting a tray switching guide 13a, the intermediate path 15, and the second sheet discharge tray 35. The first sheet discharge tray 13 is arranged on the upper side of the postprocessing unit 30 and also arranged on the upper side of the whole body of the image forming apparatus 1 (FIG. 1). The functions of the various units in the postprocessing unit 30 will be described below.

A positioning portion, such as a projected shape that fits to a recess portion on the casing 19, for positioning the casing 39 on the casing 19, i.e., first casing, of the apparatus body 10 is provided in the postprocessing unit 30. Further, a drive source and a control unit that differ from those of the apparatus body 10 are provided on the postprocessing unit 30, and by coupling a connector 36 of the postprocessing unit 30 to a connector 37 of the apparatus body 10, the postprocessing unit 30 is electrically connected to the apparatus body 10. Thereby, the postprocessing unit 30 will operate based on a command from a control unit provided in the apparatus body 10 using power supplied through the apparatus body 10.

### Process Cartridge

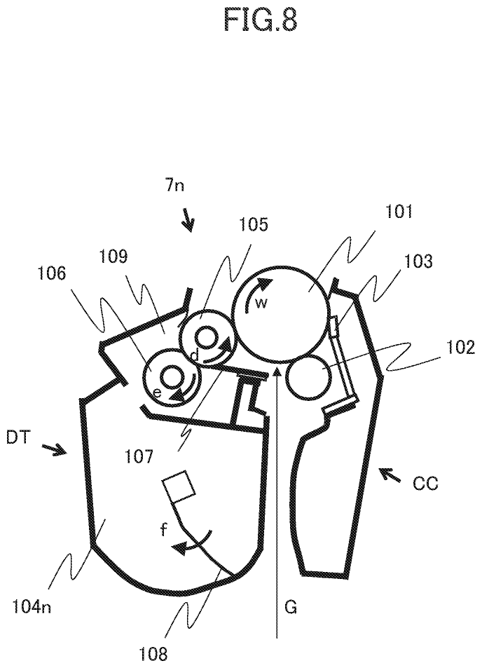

The process cartridges 7n, 7y, 7m, and 7c have approximately common configurations except for the types of powder materials stored in each of the four powder storage portions 104n, 104y, 104m, and 104c, as mentioned above. The process cartridge 7n will be described here as an example. FIG. 8 is a cross-sectional view illustrating a schematic configuration of the process cartridge 7n. The process cartridge 7n is composed of a photoreceptor unit CC including the photosensitive drum 101 and a developing unit DT including the developing roller 105.

The photosensitive drum 101 serving as an electrophotographic photoconductor, i.e., image bearing member, formed in a drum shape is attached rotatably via a bearing not shown to the photoreceptor unit CC. Further, the photosensitive drum 101 is driven to rotate in a clockwise direction (arrow w) in the drawing during image forming operation by receiving the driving force of a motor serving as a driving unit, i.e., drive source, not shown. Further, the charge roller 102 for charging the photosensitive drum 101 and a cleaning member 103 are arranged on the circumference of the photosensitive drum 101 in the photoreceptor unit CC.

The developing roller 105 serving as a developer bearing member that contacts the photosensitive drum 101 and rotates in the counterclockwise direction (arrow d) is provided in the developing unit DT. The developing roller 105 and the photosensitive drum 101 are rotated so that their surfaces are moved in the same direction at the opposing portion, i.e., contact portion.

Further, a developer supply roller, hereinafter simply referred to as “supply roller 106”, that serves as a developer supply member that rotates in the clockwise direction (arrow e) in the drawing is provided in the developing unit DT. The supply roller 106 and the developing roller 105 are rotated so that their surfaces move in the same direction at the opposing portion, i.e., contact portion. The supply roller 106 feeds the powder adhesive, or printing toner in the case of process cartridges 7y, 7m, and 7c, to the developing roller 105. At the same time, the supply roller 106 functions to scrape off the powder adhesive, or printing toner in the case of the process cartridges 7y, 7m, and 7c, remaining on the developing roller 105 from the developing roller 105. Further, a developer blade 107 serving as a developer regulation member for regulating a layer thickness of the powder adhesive, or printing toner in the case of the process cartridges 7y, 7m, and 7c, supplied on the developing roller 105 by the supply roller 106 is provided in the developing unit DT.

The powder adhesive, or printing toner in the case of the process cartridges 7y, 7m, and 7c, is stored as powder material in the powder storage portion 104n. Further, a conveying member 108 which is supported rotatably is provided in the powder storage portion 104n. The conveying member 108 rotates in the clockwise direction (arrow f) in the drawing to agitate the powder stored in the powder storage portion 104n and to convey the powder to a developing chamber 109 equipped with the developing roller 105 and the supply roller 106.

It is also possible to design the photoreceptor unit CC and the developing unit DT separately as a photoreceptor unit cartridge and a developing unit cartridge, that can be detachably attached to the image forming apparatus body. Further, it is also possible to provide the powder storage portion 104 and the conveying member 108 as a powder cartridge that can be detachably attached to the apparatus body separately from the process cartridge including the photoreceptor and the developer bearing member.

### Printing Toner

Conventionally known printing toner can be used as printing toner Tm, Tc, and Ty according to the present embodiment. Among such toner, printing toner that uses thermoplastic resin as binder resin is preferable. The thermoplastic resin is not specifically limited to a certain type of resin, and any type of thermoplastic resin that have been used conventionally in printing toner, such as polyester resin, vinyl resin, acrylic resin, and styrene-acrylic resin, can be used. Toner can contain a plurality of such resins. Specifically, printing toner using styrene-acrylic resin is preferable. Printing toner, i.e., printing developer, can contain a coloring agent, a magnetic body, a charge control agent, a wax, and an external additive.

Glass transition temperature (Tg) of printing toner Tm, Tc, and Ty can be measured using a differential scanning calorimetry analyzer “Q1000” (product of TA Instruments). Temperature correction of the detecting portion of the apparatus uses fusion points of indium and zinc, and calorific value is corrected using heat of fusion of indium. Specifically, 1 mg of a sample is subjected to precise weighing, which is put into an aluminum pan, and an empty aluminum pan is used as reference. Using a modulation measurement mode, measurement is performed in a range of 0° C. to 100° C. with a temperature elevation rate set to 1° C./min and a temperature modulation condition set to ±0.6° C./60 sec. Specific heat change is obtained during the heat elevation process, such that an intersection between a line of a midpoint of a baseline before and after acquiring the specific heat change and a differential thermal curve is set as the glass transition temperature (Tg). The acquired glass transition temperatures (Tg) of printing toner Ty, Tm, and Tc were all 77° C.

### Powder Adhesive

The powder adhesive Tn used in the present embodiment was prepared by the following manufacturing method using the following materials. That is, 36.3 to 39.8 wt. % first cyclic polyolefin resin, 18.5 wt. % second cyclic polyolefin resin, 30 wt. % cycloaliphatic saturated hydrocarbon resin, 10 wt. % or less thermoplastic elastomer or polyolefin, 1.2 wt. % charge control agent, and 4.0 wt. % releasing agent are mixed in a Henschel mixer. The acquired mixture is kneaded by a biaxial continuous kneader at a highest temperature of 180° C., cooled, crushed using a supersonic jet crusher, subjected to fine cutting by high precision crusher, and crushed into powder having a mass average particle diameter of approximately 9 μm. This powder is subjected to an external additive mixing step of 0.3 wt. % particulate silica and 0.3 wt. % alumina fine particles in a Henschel mixer to acquire the powder adhesive Tn.

The glass transition temperature (Tg) of the powder adhesive Tn can be measured by the same measurement method as printing toner Ty, Tm, and Tc using the above-mentioned differential scanning calorimetry analyzer “Q1000” (product of TA Instruments). The acquired glass transition temperature (Tg) of powder adhesive Tn was 50° C.

### Image Forming Operation

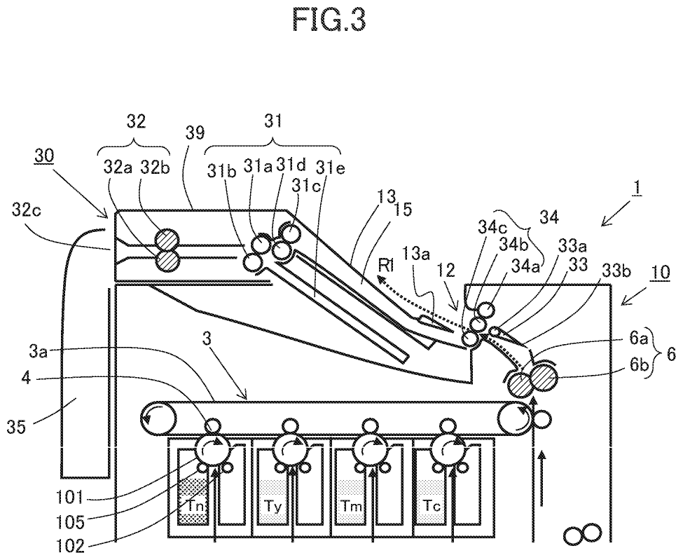

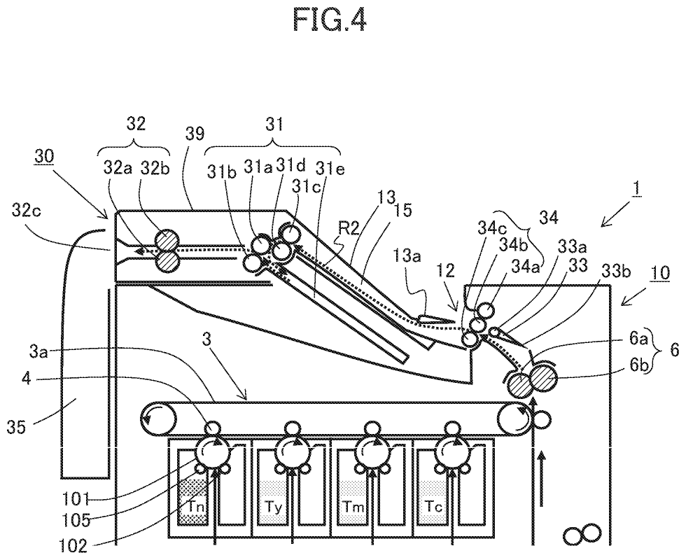

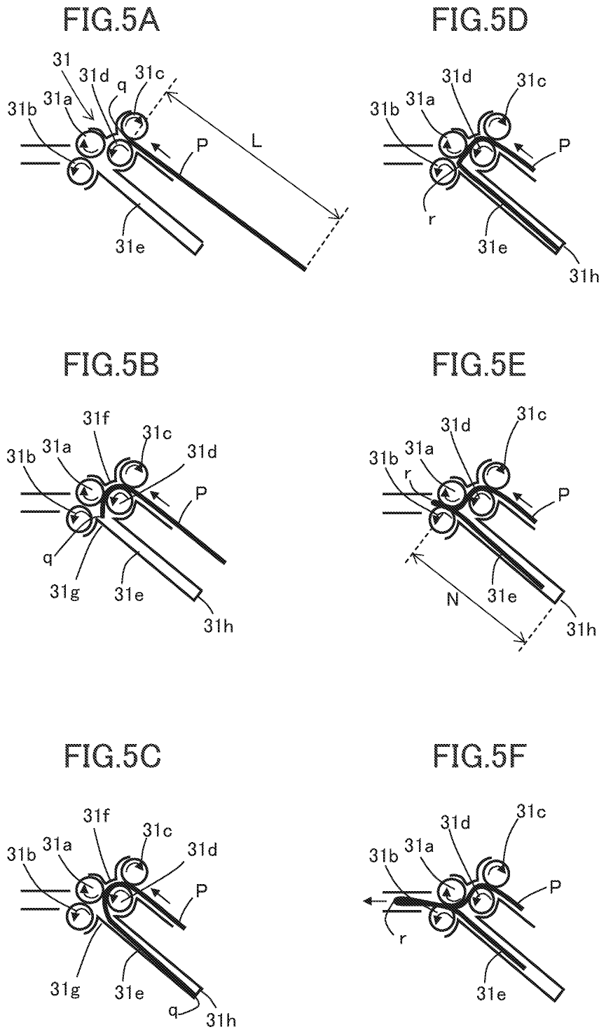

Next, an image forming operation according to the image forming apparatus 1 of the present embodiment will be described with reference to FIGS. 1 to 8. FIGS. 3 and 4 are views illustrating conveyance routes of the sheet in the image forming apparatus 1. FIGS. 5A to 5F are views illustrating the contents of the folding process.

In a state where data of the image to be printed and a command to execute printing are entered to the image forming apparatus 1, a control unit of the image forming apparatus 1 starts a sequence of operations, i.e., image forming operation, in which a sheet P is conveyed and subjected to image formation, and if necessary, subjected to postprocessing by the postprocessing unit 30. In the image forming operation, at first as illustrated in FIG. 1, the sheet P is fed one at a time from the sheet cassette 8 and conveyed via the conveyance roller 8a toward the transfer nip 5N.

In parallel with the feeding of the sheet P, the process cartridges 7n, 7y, 7m, and 7c are driven sequentially, and the photosensitive drums 101 are driven to rotate in the clockwise direction (arrow w) in the drawing. In this state, a uniform charge is applied to the surface of each photosensitive drum 101 by the charge roller 102. Further, the scanner unit 2 emits laser light G modulated according to image data to the photosensitive drums 101 of respective process cartridges 7n, 7y, 7m, and 7c, by which electrostatic latent images are formed on the surface of the photosensitive drums 101. Next, the electrostatic latent images on the photosensitive drums 101 are developed as powder material images by powder material borne on the developing rollers 105 of the process cartridges 7n, 7y, 7m, and 7c.

The powder adhesive layer formed on the photosensitive drum 101 by developing the image using the powder adhesive Tn differs from the toner image formed of printing toner for recording an image such as a figure or a text to the sheet P, that is, normal toner image, since the former does not aim at transmitting visual information. However, the layer of powder adhesive Tn developed by an electrophotographic process of applying the powder adhesive Tn to the sheet P by a predetermined application pattern can also be considered as one type of “toner image”.

The transfer belt 3a rotates in a counterclockwise direction (arrow v) in the drawing. The toner images formed on the respective process cartridges 7n, 7y, 7m, and 7c are primarily transferred from the photosensitive drums 101 to the transfer belt 3a by electric field formed between the photosensitive drum 101 and the primary transfer roller 4.

As illustrated in FIG. 1, the process cartridge 7n using the powder adhesive Tn is positioned most upstream among the four process cartridges in the direction of rotation of the transfer belt 3a. Processing cartridges 7y, 7m, and 7c of yellow, magenta, and cyan are arranged in the named order from the process cartridge 7n toward the downstream side in the direction of rotation of the transfer belt 3a. Therefore, if the four types of toner images are superposed on the transfer belt 3a, the powder adhesive Tn will constitute the lowermost layer, that is, the layer in contact with the transfer belt 3a, and printing toner of yellow (Ty), magenta (Tm), and cyan (Tc) are superposed thereon in the named order.

The toner image borne on the transfer belt 3a and having reached the transfer nip 5N is secondarily transferred to the sheet P conveyed through the main conveyance path 1m by electric field formed between the secondary transfer roller 5 and the secondary transfer inner roller 3b. In that state, the order of the toner layers in the vertical direction is reversed. That is, from the lowermost layer, or layer in contact with the sheet P, printing toner of cyan (Tc), magenta (Tm) and yellow (Ty) are superposed to the sheet P having passed through the transfer nip 5N, and the layer of powder adhesive Tn is formed on top. Thus, the layer of powder adhesive Tn is formed on the uppermost surface of the toner image transferred to the sheet P.

Thereafter, the sheet P bearing the unfixed toner image is nipped and conveyed together with the fixing film 6a in the fixing nip 6N while having the image surface side of the sheet P being in close contact with the outer surface of the fixing film 6a at the fixing nip 6N. During the nipping and conveying process, the heat from the heater 6a1 is applied on the image surface of the sheet P via the fixing film 6a, by which printing toner Ty, Tm, and Tc and the powder adhesive Tn are melted and fixed on the sheet P. The sheet P having passed through the fixing nip 6N is separated from the fixing film 6a due to the curvature of the film while maintaining the fixed toner image, by which an image fixed to the sheet P is obtained.

The sheet P discharged from the apparatus body 10 is nipped by the intermediate roller 34b and the second sheet discharge roller 34c regardless of whether the printing is one-side printing or duplex printing, as illustrated in FIGS. 3 and 4, and the sheet P is either conveyed to a first route R1 or a second route R2 by the tray switch guide 13a.

The first route R1 illustrated in FIG. 3 is a route through which the sheet P having passed through the fixing unit 6 is discharged by the sheet discharge unit 34 to the first sheet discharge tray 13 in a normal printing mode where the postprocessing unit 30 is not used. The second route R2 illustrated in FIG. 4 is a route through which the sheet P having passed through the fixing unit 6 is conveyed via the sheet discharge unit 34, the folding unit 31, and the bonding unit 32 to be discharged to the second sheet discharge tray 35 in a print-and-bond mode.

The intermediate path 15 is provided between the fixing unit 6 and the folding unit 31 in the second route R2. The intermediate path 15 is a sheet conveyance path that passes the upper surface portion, i.e., top panel portion, of the image forming apparatus 1, and extends approximately in parallel with the first sheet discharge tray 13 at the lower side of the first sheet discharge tray 13. The intermediate path 15 and the first sheet discharge tray 13 are inclined upward in the vertical direction toward the folding unit 31 with respect to the horizontal direction. Therefore, an inlet port of the folding unit 31, that is, the guide roller pair (31c and 31d) described below, is positioned upward in the vertical direction than an outlet port of the apparatus body 10, that is, the nip between the intermediate roller 34b and the second sheet discharge roller 34c.

The folding unit 31 includes four rollers, which are a first guide roller 31c, a second guide roller 31d, a first folding roller 31a, and a second folding roller 31b, and a drawing portion 31e. The first guide roller 31c and the second guide roller 31d are a guide roller pair that nips and conveys the sheet P received from a conveyance path arranged upstream of the folding unit 31, which is the intermediate path 15 according to the present embodiment. The first folding roller 31a and the second folding roller 31b constitute a folding roller pair that folds the sheet P while conveying the sheet P.

A distance M (FIG. 1) from the second sheet discharge roller 34c to the first guide roller 31c in the sheet conveyance direction along the second route R2 is designed to be shorter than a total length L (FIG. 5A) in the conveyance direction of the sheet P prior to the folding process. In other words, a lower limit of the conveyance direction length of the sheet that can be processed by the postprocessing unit 30 is determined by the distance M from the second sheet discharge roller 34c to the first guide roller 31c. According to this configuration, the sheet P is transferred smoothly from the sheet discharge unit 34 to the guide roller pair.

A folding process performed by the folding unit 31 will be described with reference to FIGS. 5A to 5F. When executing the folding process, the first guide roller 31c and the first folding roller 31a are rotated in the clockwise direction, and the second guide roller 31d and the second folding roller 31b are rotated in the counterclockwise direction in the drawing. At first, a leading edge q of the sheet P conveyed from the sheet discharge unit 34 is drawn into the guide roller pair (31c and 31d), as illustrated in FIG. 5A. The leading edge q of the sheet P is guided downward by a guide wall 31f, comes into contact with the first folding roller 31a, and is drawn by the first folding roller 31a and the second guide roller 31d which are opposed to each other, and comes into contact with a wall 31g of the drawing portion 31e, as illustrated in FIG. 5B.

Along with the drawing of the sheet P by the guide roller pair (31c and 31d), the leading edge q moves toward the bottom of the drawing portion 31e while sliding against the wall 31g. Then, as illustrated in FIG. 5C, the leading edge q abuts against an end portion 31h of the drawing portion 31e. The drawing portion 31e forms a space that is extended approximately parallel to the intermediate path 15 at the lower side of the intermediate path 15, and in the state illustrated in FIG. 5C, the sheet P is curved in a U shape by being wound around the second guide roller 31d.

As the sheet P is drawn further by the guide roller pair (31c and 31d) from the state illustrated in FIG. 5C, a warp starts to build at a middle part r, as illustrated in FIG. 5D. Then, when the middle part r contacts the second folding roller 31b, the middle part is drawn into the nip portion of the folding roller pair (31a and 31b) by frictional force received from the second folding roller 31b, as illustrated in FIG. 5E. Then, the sheet P in the folded state with the middle part r serving as a folding line is discharged with the middle part r positioned as the leading edge by the folding roller pair (31a and 31b), as illustrated in FIG. 5F.

A depth N of the drawing portion 31e (FIG. 5E), that is, the distance from the nip portion of the folding roller pair (31a and 31b) to the end portion 31h of the drawing portion 31e, is set to half the total length L of the sheet P. Thereby, the folding unit 31 can execute a process of folding the sheet P in two at half the sheet length, i.e., center folding. The position of the folding line can be changed arbitrarily by changing the depth N of the drawing portion 31e.

The folding unit 31 described above is an example of the folding portion, and other folding mechanisms can be adopted, such as a folding mechanism in which a folding line is formed by pressing a blade against the sheet P and pushing the sheet into the nip portion of a roller pair. Not only a two-fold folding process but also a Z-shaped fold or a three-fold folding process can be executed by the folding mechanism. Since the folding unit 31 according to the present embodiment is composed of rollers that are rotated and the drawing portion 31e that is fixed, the driving mechanism thereof can be simplified compared to the folding mechanism using a blade that moves in reciprocating motion. Further, the folding unit 31 according to the present embodiment only requires the drawing portion 31e having the depth N set to half the sheet length in addition to the four rollers, such that the postprocessing unit 30 can be downsized.

The sheet P that has been folded by folding unit 31 is conveyed to the bonding unit 32, where the sheet P is subjected to a bonding process where the sheet receives heat and pressure while being nipped and conveyed by the bonding nip 32N. The sheet P is bonded in the state folded as illustrated in FIG. 10 by receiving the bonding process, which is a second heat fixing performed to the image surface to which the powder adhesive has been applied. In other words, in a state where the powder adhesive Tn on the sheet P is heated and softened again when the sheet P is passed through the bonding nip 32N and pressed, the inner side surfaces of the sheet P are bonded, or adhered, via the powder adhesive Tn.

The sheet P having been subjected to the bonding process by the fixing unit 32 is discharged to a left side of the drawing through a sheet discharge port 32c, i.e., second sheet discharge port, provided on the casing 39 of the postprocessing unit 30, as illustrated in FIG. 4. The sheet P is then stored in the second sheet discharge tray 35 provided on the left side of the apparatus body 10 (refer to FIG. 1). Thereby, the image forming operation in which the sheet P is conveyed through the second route R2 is ended.

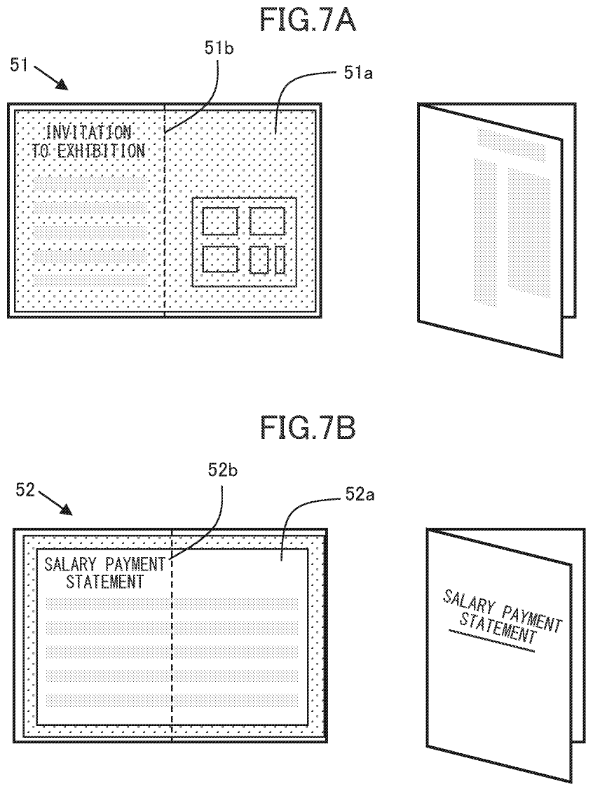

The bonding area of the sheet P being folded can be changed according to the application pattern of the powder adhesive Tn on the sheet P. FIGS. 7A and 7B illustrate examples of products in which application patterns of the powder adhesive Tn differ. The illustrated products are semi-bonded printed products, the purpose of use of which is to be opened by a receiver. In the case of a pressure-bonded postcard (i.e., peel-and-reveal type postcard) 51 of FIG. 7A, the powder adhesive Tn is applied to a whole surface 51a of one side of the sheet P, and the sheet is folded at a center folding line 51b and bonded. In the case of a salary payment statement 52 illustrated in FIG. 7B, the powder adhesive Tn is applied to a whole outer circumference 52a of one side of the sheet P, and the sheet is folded at a center folding line 52b and bonded. In another example, the powder adhesive Tn can be applied to three sides of a rectangular shape on the outer circumference portion of the sheet P such that an opening is formed in a state where the sheet P is folded, to thereby form a paper pouch, i.e., bag or envelope. Moreover, a completely bonded printed product that is not assumed to be opened can be formed.

According to the image forming apparatus 1 of the present embodiment, both the products illustrated in FIGS. 7A and 7B can be output in a single step from a base sheet without preparing a pre-printed sheet in advance. That is, the present embodiment enables to create a bonding layer formed by applying the powder adhesive Tn in a predetermined pattern in parallel with the operation of recording an image on one side or on both sides of the sheet P using printing toner to thereby output a product subjected to both the folding process and the bonding process. For example, when outputting products illustrated in FIGS. 7A and 7B, one side of the sheet P used as the base sheet constitutes an outer side of the product, and the other side of the sheet P constitutes an inner side of the product. Therefore, in duplex printing, an image to be printed on the outer side is formed using printing toner as the image forming operation on the first side, and an image to be printed on the inner side can be formed using printing toner while having the bonding layer formed by applying the powder adhesive Tn according to a predetermined application pattern as the image forming operation on the second side.

The image recorded using printing toner by the image forming apparatus 1 can include a format portion, i.e., unchanged portion, that has been printed on a pre-printed sheet, and a variable portion such as personal information. Therefore, as described above according to the present embodiment, a product bonded by the bonding process can be output using a base sheet such as white paper, which is not a pre-printed sheet. However, the image forming apparatus 1 according to the present embodiment can also be used with the purpose of performing a printing process of the variable portion and the bonding process using the pre-printed sheet as the recording medium.

In the present embodiment, the sheet conveyance speeds of the fixing unit 6 and the bonding unit 32 are set to the same speed (210 mm/sec). In a case where the size of the sheet passing through the fixing unit 6 is A4 (210 mm×297 mm), the size of the two-folded product, such as the pressure-bonded postcard, formed by the postprocessing unit 30 is A5 (149 mm×210 mm). The sheet P used for considering conditions of the bonding process by the bonding unit 32 described below was Red Label Presentation (grammage 80 g/m², A4 sheet size), which is a product of Canon Inc.

### Consideration on Conditions of Bonding Process

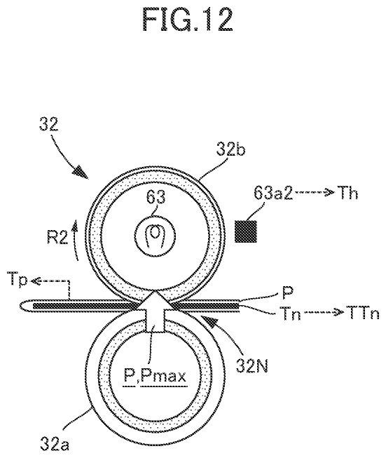

Next, a result of consideration on conditions of the bonding process enabling to realize both suppression of hot offset and sufficient bonding strength will be described. FIG. 12 is a schematic drawing illustrating setting conditions during bonding of the sheet P by the bonding unit 32. Table 1 is a table showing evaluation results (f) on whether hot offset has occurred to the sheet surface and evaluation results (g) on adhesiveness of an inner side of the sheet when a pressure-bonded postcard (FIG. 7A) was created as a printed-and-bonded product by varying setting conditions (a to e) during bonding.

TABLE 1

| | EX. 1 | | EX. 2 | | EX. 3 | | EX. 4 | | EX. 5 | | EX. 6 | |
|---|---|---|---|---|---|---|---|---|---|---|---|---|
| (a) TARGET TEMPERATURE Th | 160° | C. | 24° | C. | 24° | C. | 140° | C. | 160° | C. | 200° | C. |
| OF SURFACE OF HEATING | | | | | | | | | | | | |
| ROLLER | | | | | | | | | | | | |
| (b) PRESSING FORCE Pt OF | 45 | kgf | 45 | kgf | 90 | kgf | 45 | kgf | 20 | kgf | 45 | kgf |
| BONDING UNIT | | | | | | | | | | | | |
| (c) MAXIMUM SURFACE | 0.24 | MPa | 0.24 | MPa | 0.48 | MPa | 0.24 | MPa | 0.10 | MPa | 0.24 | MPa |
| PRESSURE Pmax OF BONDING | | | | | | | | | | | | |
| NIP | | | | | | | | | | | | |
| (d) SHEET SURFACE | 100° | C. | 24° | C. | 24° | C. | 75° | C. | 90° | C. | 130° | C. |
| TEMPERATURE Tp | | | | | | | | | | | | |
| (e) INNER SIDE TEMPERATURE | 65° | C. | 24° | C. | 24° | C. | 40° | C. | 60° | C. | 80° | C. |
| OF SHEET (POWDER | | | | | | | | | | | | |
| ADHESIVE TEMPERATURE) Ttn | | | | | | | | | | | | |

| | | | | | | |
|---|---|---|---|---|---|---|
| (f) HOT OFFSET ON SHEET | GOOD | GOOD | GOOD | GOOD | GOOD | POOR |
| SURFACE | | | | | | |
| (g) ADHESIVENESS OF INNER | GOOD | POOR | POOR | POOR | POOR | GOOD |
| SIDE OF SHEET | | | | | | |

The respective setting conditions (a) to (e) will be described. Condition (a) is a target temperature Th of the surface temperature of the heating roller 32b of the bonding unit 32, wherein an arbitrary target temperature can be set to a CPU 63a3 (FIG. 10). Condition (b) is a pressing force Pt of the bonding unit 32, which is adjustable by adjusting a spring constant of a spring member used for the pressurizing mechanism or a deformation thereof in a mounted state. The pressing force Pt is a magnitude of force in which the heating roller 32b and the pressure roller 32a constituting the second rotary member pair are pressed in a sheet thickness direction, which is perpendicular to both the sheet conveyance direction and the longitudinal direction at the bonding nip 32N. Condition (c) is a maximum surface pressure Pmax of the bonding nip 32N, which can be adjusted by the pressing force Pt of (b). Further, the maximum surface pressure Pmax is varied by diameters of the heating roller 32b and the pressure roller 32a, and Young's modulus and thickness of the elastic layers 32a2 and 32b2 and the release layers 32b3 and 32a3. The maximum surface pressure Pmax is a peak value, i.e., maximum value (refer to FIG. 11C) of a result of having plotted a pressure distribution acting on respective unit areas of the sheet surface when the sheet S passes through the bonding nip 32N.

Condition (d) is a sheet surface temperature Tp, i.e., highest temperature, in a state where the sheet passes through the bonding nip 32N. Specifically, a thermocouple is attached to a surface on the heating roller 32b-side of the sheet, and while the sheet is passed through the bonding nip 32N, the surface temperature detected by the thermocouple is acquired by a data logger, wherein a maximum value thereof is set as the sheet surface temperature Tp. Condition (e) is an inner side temperature Ttn of the sheet in a state where the sheet in the folded state is passed through the bonding nip 32N. In other words, Ttn is a highest temperature of the powder adhesive Tn during a period in which the sheet in the folded state is passed through the bonding nip 32N. The measurement method is similar to the sheet surface temperature Tp, wherein the thermocouple is adhered to a side of the sheet that is placed on the inner side when folded, and the temperature detected by the thermocouple while the sheet passes through the bonding nip 32N is acquired by the data logger, the maximum value of which is set as the sheet inner side temperature Ttn.

Condition (f) shows an evaluation through naked eyes of hot offset on the heating roller 32b-side surface of the sheet, that is, upper side of the sheet P in FIG. 10, having passed through the bonding unit 32, wherein the result was evaluated as good if no image defects caused by hot offset was visible and poor if image defects were visible. Hot offset occurs by printing toner on the sheet P being adhered on the heating roller 32b and the adhered toner being reattached to the sheet P after the heating roller 32b rotates once, by which the sheet P is soiled. Therefore, the image defect caused by the hot offset is typically the soiling caused by the toner appearing at a position displaced in the sheet conveyance direction for a distance corresponding to the outer circumference length of the heating roller 32b from the proper image formed on the sheet P. Condition (g) shows the quality of the adhesiveness determined by leaving the created pressure-bonded postcard for 24 hours under an environment atmosphere at a temperature of 23° C. and a humidity of 50%, and checking whether the bonded surface has been naturally detached, wherein if the bonded surface was not detached, the adhesiveness was evaluated as good, and if the bonded surface was detached, the adhesiveness was evaluated as poor.

In Example 1, (a) the target temperature Th of the heating roller 32b was 160° C., the pressing force Pt of the bonding unit 32 was 45 kgf (approximately 440 N), and the maximum surface pressure Pmax of the bonding nip 32N was 0.24 MPa. As for the temperature conditions of (d) and (e), (d) the sheet surface temperature Tp was 100° C., and (e) the sheet inner side temperature Ttn was 65° C. In that case, (f) no image defects by hot offset occurred to the sheet surface, and (g) the adhesiveness of the inner side of the sheet was good. That is, the bonding conditions of Example 1 is an example of favorable conditions.

According to Example 2, (b) the pressing force Pt of the bonding unit 32 was the same as Example 1, but it shows a case where heating of the heating roller 32b was not performed, i.e., (a) the target temperature Th of the heating roller 32b was approximately equal to room temperature. In that case, (f) image defects by hot offset did not occur on the sheet surface, but (g) the inner side of the sheet was not bonded at all.

Example 3 illustrates a case where (b) the pressing force Pt of the bonding unit 32 was set to twice that of Example 1, and heating of the heating roller 32b was not performed. Also according to that case, (f) image defects by hot offset did not occur on the sheet surface, but (g) the inner side of the sheet was not bonded at all.

Examples 2 and 3 did not heat the heating roller 32b of the bonding unit 32, such that even if the sheet was passed through the bonding unit 32, (e) the temperature of the powder adhesive Tn on the inner side of the sheet was not raised. The glass transition temperature of the powder adhesive Tn used in the present embodiment was approximately 50° C., and below that temperature range, the viscoelasticity of the powder adhesive Tn was not lowered much. Therefore, even according to the configuration of Example 3 in which the pressing force Pt of the bonding unit 32 was increased without heating the heating roller 32b, the viscoelasticity of the layer of power adhesive Tn was not lowered when the sheet was passed through the bonding unit 32. As a result, it is considered that even if a relatively large maximum surface pressure Pmax was applied to the sheet, the surfaces of the layers of powder adhesive Tn facing each other in the inner side of the sheet in the folded state was not sufficiently in close contact with each other, such that bonding failure had occurred.

According to Example 4, (b) the pressing force Pt of the bonding unit 32 was set to twice that of Example 1, and (a) the target temperature Th of the surface of the heating roller was set to 140° C. However, even according to these conditions, (f) image defects by hot offset did not occur on the sheet surface, but (g) the adhesiveness of the inner side of the sheet was insufficient. It is considered that even though the heating roller 32b was heated, the target temperature Th was low, such that (e) the sheet inner side temperature Ttn did not reach the glass transition temperature.

According to Example 5, (a) the target temperature Th of the heating roller surface was set to 160° C., which is the same as Example 1, and (b) the maximum surface pressure Pmax of the bonding nip 32N was set to a value (0.10 MPa) that is lower than Example 1. According to Example 5, the temperature of the powder adhesive Tn was equal to or greater than the glass transition temperature when the sheet was passed through the bonding unit 32, such that the viscoelasticity of the powder adhesive Tn layer was lowered. However, since the maximum surface pressure Pmax was low, the surfaces of the layers of powder adhesive Tn that face each other on the inner side of the sheet in the folded state was not sufficiently in close contact with each other, which is considered to have caused bonding failure.

According to Example 6, (b) the maximum surface pressure Pmax of the bonding nip 32N was set to the same value as Example 1, and (a) the target temperature Th of the heating roller surface was set to 200° C., which is higher than Example 1. In that case, excessive heat was supplied from the heating roller 32b to the sheet and (d) the sheet surface temperature Tp became too high, such that (f) hot offset had occurred. Meanwhile, since the temperature of the powder adhesive Tn became equal to or higher than the glass transition temperature and sufficiently large maximum surface pressure Pmax was applied, (g) the adhesiveness by the powder adhesive Tn on the inner side of the sheet was sufficient.

As can be recognized from the test results described above, by setting the peak value of the nip pressure at the bonding nip 32N to be greater than the peak value of the nip pressure at the fixing nip 6N, sufficient bonding strength was obtained even if the setting of the heating temperature (Th) during bonding was set lower. That is, in a case where the nip pressure of the bonding nip 32N was equal to or smaller than that of the fixing nip 6N, bonding failure occurred if the target temperature Th of the bonding unit 32 was set to 160° C. (Example 5). Meanwhile, if the peak value (Pmax) of the nip pressure of the bonding nip 32N was set greater than the peak value of the nip pressure of the fixing nip 6N, a sufficient bonding strength was obtained even if the target temperature Th of the bonding unit 32 was set to 160° C. (Example 1). Further, by setting the peak value (Pmax) of the nip pressure of the bonding nip 32N higher than the peak value of the nip pressure of the fixing nip 6N, according to Example 1, a good adhesiveness was obtained without having to raise the target temperature Th of the bonding unit 32 to a temperature range causing hot offsets, as in Example 6.

In the present embodiment, hot offset was taken as an example of a demerit of excessively raised target temperature Th of the bonding unit 32, but if the target temperature Th can be maintained low, reduction of power consumed by the bonding unit 32, i.e., enhancement of energy saving property, can be expected. Further, by setting the target temperature Th low, heating of the casing of the postprocessing unit 30 is suppressed. Accordingly, if sufficient bonding strength can be obtained, it is desirable that the heating temperature during bonding is low. The setting conditions of bonding illustrated in Table 1 are merely an example, and the preferable conditions may vary depending on the physical properties, especially the glass transition temperatures, of printing toner and powder adhesive, and the material of the sheet P.

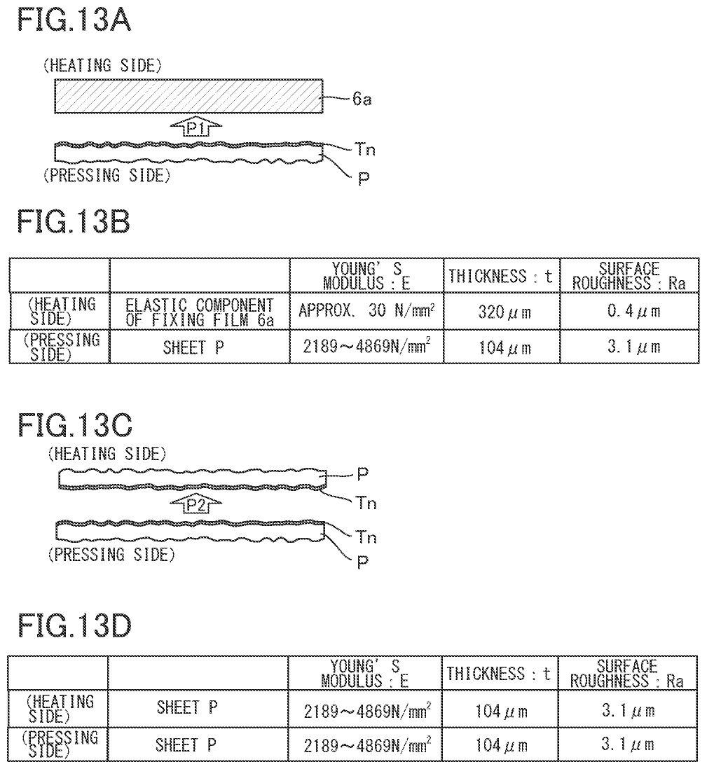

The reason why the adhesiveness of the sheet P by the bonding unit 32 is improved by setting the peak value (Pmax) of nip pressure of the bonding nip 32N to be higher than the peak value of nip pressure of the fixing nip 6N will be described with reference to FIGS. 13A to 13D.

FIG. 13A is a schematic diagram illustrating a state of contact between the fixing film 6a and the sheet P at the fixing nip 6N of the fixing unit 6. FIG. 13B illustrates numerical example of parameters related to close contactness of the fixing film 6a and the sheet P. In order to fix the powder adhesive Tn to the sheet P by heat and pressure, i.e., fixing process, at the fixing nip 6N, the close contactness of the surface of the fixing film 6a and the surface of the sheet P is important. The close contactness of the surface, i.e., heat-side surface, of the fixing film 6a and the surface, i.e., pressure-side surface, of the sheet P is known to relate to a Young's modulus E representing stiffness of each elastic component, a thickness t of the elastic component, a surface roughness, i.e., Ra value, of the contact surface, i.e., interface, and a pressing force P1 at the fixing nip. In order for the heat-side surface and the pressure-side surface to be in close contact with each other, it is necessary for the unevenness on one of the surfaces to be aligned with the other surface by elastic deformation of the heat-side elastic component and the pressure-side elastic component. The close contactness becomes higher as thickness t and pressing force P1 increase, and the close contactness becomes higher as the Young's modulus E and the surface roughness Ra decrease.

The elastic component of the fixing film 6a according to the present embodiment only refers to the elastic layer and the release layer, and the base layer having a high stiffness was excluded. Further, the sheet P had an approximately entirely uniform elasticity. The Young's modulus E was obtained by cutting the samples into strips of 15 mm×120 mm, fixing an end of each sample by a chuck member, and measuring a stress of extending the sample in a long side direction at a speed of 1.0 mm/sec using a load cell of a measuring instrument. A tabletop testing machine EZ-Test, which is a product of Shimadzu Corp., was used. Further, as for the fixing film 6a, the elastic layer and the release layer were cut off and separated from the base layer using a cutter knife, and only the elastic component was used to create the sample.

FIG. 13C is a schematic diagram illustrating a state of contact between surfaces of the sheet Pin the folded state at the bonding nip 32N of the bonding unit 32. FIG. 13D illustrates a numerical example of parameters related to close contactness between the surfaces of the sheet P. In order to bond the surfaces of the sheet P together by heat and pressure, i.e., bonding process, at the bonding nip 32N, the close contactness between the surfaces of the sheet P is important. It is known that the close contactness between the surfaces of the sheet P is related to the Young's modulus E and the thickness t of the sheet P, the surface roughness, i.e., Ra value, of the surfaces being in contact with each other, i.e., interface, and a pressing force P2 at the bonding nip 32N. In order for the surfaces of the sheet P to be in close contact with each other, it is necessary for the unevenness on one of the surfaces to be aligned with the other surface by elastic deformation of the sheet P. The close contactness becomes higher as the thickness t and the pressing force P2 increase, while the close contactness becomes higher as the Young's modulus E and the surface roughness Ra decrease.

By comparing FIGS. 13A and 13B with FIGS. 13C and 13D, it can be recognized that the Young's modulus E, the thickness t, and the surface roughness Ra of the sheet P normally have a disadvantageous effect on close contactness compared to the Young's modulus E, the thickness t, and the surface roughness Ra of the elastic component of the fixing film 6a. In other words, the Young's modulus E and the surface roughness Ra of the sheet P is generally greater than the Young's modulus E and the surface roughness Ra of the fixing film 6a, and the thickness t of the sheet P is generally smaller than the thickness t of the fixing film 6a. Therefore, in order for the close contactness between surfaces of the sheet P at the bonding nip 32N to be equal to or greater than the close contactness between the fixing film 6a and the sheet P at the fixing nip 6N, the pressing force P2 at the bonding nip 32N is set greater than the pressing force P1 of the fixing unit 6 (P2>P1).

Specifically, based on the test described with reference to Table 1, it is recognized that it is preferable for the maximum surface pressure Pmax of the bonding nip 32N to be 0.2 MPa or greater. Meanwhile, sufficient fixity was obtained by setting the maxim surface pressure of the fixing nip 6N to approximately 0.1 MPa, such as 0.15 MPa or lower. That is, the peak value of pressure that the bonding unit 32 applies to the sheet at the bonding nip 32N, which according to the example of FIG. 11C is 0.24 MPa, is preferably two times or more greater than the peak value of pressure that the fixing unit 6 applies to the sheet at the fixing nip 6N, which according to the example of FIG. 11A is 0.12 MPa.

Red Label Presentation (grammage 80 g/m², A4 sheet size), which is a product of Canon Inc., was used as the sheet P in the above-described test. The sheet P is not limited to this example, and other sheets generally be used as recording medium in an electrophotographic image forming apparatus, such as normal paper, thick paper, gloss paper, and rough paper having a grammage in the range of 60 g/m² to 230 g/m², can be used. The Young's modulus E of these sheets is approximately 1000 to 8000 N/mm, the thickness t thereof is approximately 80 to 260 and the surface roughness Ra thereof is approximately 0.8 to 5.5 Therefore, in most cases, the elastic component of the fixing film 6a is more advantageous from the viewpoint of close contactness than the sheet P. Accordingly, regarding most sheets used for electrophotography, a good adhesiveness can be obtained by setting the pressing force P2 at the bonding nip 32N greater than the pressing force P1 at the fixing nip 6N (P2>P1). In other words, regarding the heating member, i.e., first heating member, at the fixing unit 6, the Young's modulus is preferably less than 1000 N/mm² (1 GPa), the thickness is preferably greater than 260 for example, and the surface roughness Ra is preferably less than 0.8 μm, for example. However, a heating member that satisfies only some of these conditions can be used.

Further, in order to suppress the hot offset of printing toner in the bonding process, it is preferable that the target temperature (Th) of the bonding unit 32 is set lower than the target temperature of the fixing unit 6 so as to suppress the calorific value applied to the sheet at the bonding nip 32N. Especially, it is preferable that the glass transition temperature of the powder adhesive is set lower than the glass transition temperature of printing toner, and that the calorific value applied to the sheet P at the bonding nip 32N is as low as possible within the range in which a good adhesiveness can be obtained by the powder adhesive. A criterion of achieving a good adhesiveness by the powder adhesive is that the highest temperature of the powder adhesive when passing through the bonding nip 32N becomes equal to the glass transition temperature of the powder adhesive or higher.

As described above, the configuration of the present embodiment enables to achieve a sufficient bonding strength without setting the heating temperature during bonding to an excessively high value.

### OTHER EMBODIMENTS

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-106559, filed on Jun. 28, 2021, which is hereby incorporated by reference herein in its entirety.

What is claimed is:

1. An image forming apparatus comprising:
an image forming portion configured to form a toner image on a sheet using printing toner and to apply powder adhesive on the sheet;
a fixing portion including a first rotary member pair that constitutes a first nip portion, the fixing portion being configured to heat and press the sheet conveyed from the image forming portion while nipping and conveying the sheet by the first nip portion to fix the toner image to the sheet;
a folding portion configured to fold the sheet conveyed from the fixing portion such that a surface of the sheet on which the powder adhesive is applied is placed on an inner side of the sheet that is folded; and
a bonding portion including a second rotary member pair that constitutes a second nip portion, the bonding portion being configured to heat and press the sheet folded by the folding portion while nipping and conveying the sheet by the second nip portion to bond the sheet by the powder adhesive,
wherein a peak value of pressure that the second rotary member pair applies to the sheet in the second nip portion is greater than a peak value of pressure that the first rotary member pair applies to the sheet in the first nip portion.

2. The image forming apparatus according to claim 1,
wherein the peak value of pressure that the second rotary member pair applies to the sheet in the second nip portion is 0.2 MPa or greater.

3. The image forming apparatus according to claim 1,
wherein the peak value of pressure that the second rotary member pair applies to the sheet in the second nip portion is two times the peak value of pressure that the first rotary member pair applies to the sheet in the first nip portion or greater.

4. The image forming apparatus according to claim 1,
wherein the fixing portion includes a first heating mechanism,
wherein the first rotary member pair includes a first heating member configured to be heated by the first heating mechanism.
wherein the bonding portion includes a second heating mechanism,
wherein the second rotary member pair includes a second heating member configured to be heated by the second heating mechanism, and
wherein a target temperature of a surface of the second heating member in a case where the bonding portion bonds the sheet is lower than a target temperature of a surface of the first heating member in a case where the fixing portion fixes the toner image to the sheet.

5. The image forming apparatus according to claim 4,
wherein a glass transition temperature of the powder adhesive is lower than a glass transition temperature of the printing toner, and
wherein the target temperature of the surface of the second heating member is set such that a highest temperature of the powder adhesive while the sheet passes through the second nip portion is equal to or higher than the glass transition temperature of the powder adhesive.

6. The image forming apparatus according to claim 1,
wherein a width of the second nip portion in a sheet conveyance direction is shorter than a width of the first nip portion in the sheet conveyance direction.
